(19) United States
(12) Patent Application Publication
(10) Pub. No.: US 2006/0221597 A1
(43) Pub. Date: Oct. 5, 2006

(54) Electro-luminescent performance apparrel

(76) Inventor: Sean Gregory Hutchinson, Gaston, NC (US)

Correspondence Address: Sean Gregory Hutchinson, P.O. Box 993, Gaston, NC, 27832, US

(21) Appl. No.: 11/188,501

(22) Filed: Jul. 25, 2005

Related U.S. Application Data
(60) Provisional application No. 60/667,139, filed on Mar. 30, 2005.

(51) Int. Cl. F21V 21/08

(52) U.S. Cl. 362/103

(57) ABSTRACT

Sport performance apparel be it motorcycle jackets, helmets, ski jackets, pant, biking, etc, to which a flat electro-luminescent lamp has been added to illuminate upon activation of braking (on a motorcycle) or upon manual activation (recreational, professional purposes, and at dance clubs), using wireless circuitry to increase visibility of the wearer in all light conditions.

### CROSS REFERENCE TO RELATED APPLICATIONS

| | | | |
|---|---|---|---|
| 1. | Patent No. 6,834,395 | Fuentes | December, 2004 |
| 2. | Patent No. 6,679,615 | Spearing | January, 2004 |
| 3. | Patent No. 6,538,567 | Stewart | March, 2003 |
| 4. | Patent No. 6,012,822 | Robinson | January, 2000 |
| 5. | Patent No. 5,440,461 | Nadel | August, 1995 |
| 6. | Patent No. 4,709,307 | Branum | November, 1997 |
| 7. | Publication No. 20010004808 | Hurwitz | June, 2001 |

### BACKGROUND OF THE INVENTION

Electro-luminescent performance apparel pertains to the field of sportswear, and is intended primarily for the purpose of increased safety and visibility of the wearer by incorporating the use of electro-luminescent encapsulated fibers in the form of a flat electro-luminescent lamp and to increase relative comfort by using wireless transmitting and receiving circuits to activate the flat lamp. For example, at night, in low-light conditions, a motorcyclist while riding is not as visible as a car with its lights on. The motorcyclist can apply brakes and still not be comparable to the visibility of a cars' taillights. As a result, motorcyclists are rear-ended by other, larger vehicles. On the other hand, if the motorcyclist was wearing an electro-luminescent enhanced jacket which activated when the brakes were applied or was set to stay activated at night or low-light conditions regardless of brakes, the motorcyclist would be much more visible and would stand less of a chance of being struck. Electro-luminescent performance apparel may also have recreational off-road purposes for non-motorists such as sport enthusiasts or at dance clubs. The aforementioned apparel is not to be confused with patent #20010004808 wherein a wire-like design is primarily used and the nature of the fibers of the lamp are not mentioned. Furthermore, the use of the wireless circuits used to activate the E.L. apparel are not mentioned. Electro-luminescent apparel primarily makes use of the flat, sheet-like electro-luminescent material, comprising of encapsulated electro-luminescent fibers phosphors or otherwise, which is by far, more visible in low light conditions,

There have been many attempts made to increase the safety and visibility of low-light condition apparel. Of these the use of reflective garments has mainly been incorporated. The downfall of this is that there must be light influencing the reflective object to make it visible,

There have also been numerous attempts to create lighted apparel by incorporating LED's and wire-like electro-luminescent lamps. The major downfall of these attempts are lack of high visibility per unit used and the amount of each material that must be used before an undisputed level of visibility in low-light or no light conditions can be achieved.

In studying these methods, one would come to the conclusion that they do not fully satisfy the problem at hand, whether it is the nature of the material (i.e. reflective) needing light in order to operate, or whether it is the fact that the material (i.e. E.L. wire-like and LED's) need to be used in high volume to achieve the visibility goal which leads to excessive use of wires and foundations making he apparel rather heavy and uncomfortable,

E.L. performance apparel makes use of a new type of E.L. flat lamp containing encapsulated electro-luminescent fibers activated by a wireless transmitting and receiving circuit. The flat lamp used in the invention when activated is much more luminous than the aforementioned LED's and E.L. wire-like lamps. The fact that this apparel incorporates a wireless transmitting and receiving circuit, alleviates the excessive use of wires and keeps the E.L. apparel lighter and more comfortable than the previous methods.

### SUMMARY OF THE INVENTION

The purpose of this invention is to increase the visibility and safety of the wearer in no light and low-light conditions and to increase the level of comfort of the wearer. The purposes are met by using the new forms of electro-luminescent flat lamps activated by any wireless transmitting and receiving circuit.

The purpose of this invention is also met by the permanent or temporary attachment of the aforementioned E.L. flat lamp to the apparel and to the power circuit integral of the apparel or separate from the apparel itself.

The purpose of this invention is also met when the E.L. flat lamp is protected from water or other substances with any screen be it solid like glass, plastic, or a mesh of material layered in any cross-hatch pattern allowing the light from the E.L. flat lamp to be seen.

The purpose of this invention is also met by the addition of a wireless transmitting and receiving circuit controlling current flow to the E.L. flat lamp, be it radio, infra-red, blue tooth or otherwise.

The purpose of this invention is also met by using a flat electro-luminescent lamp incorporating electro-luminescent fibers be it phosphors silicon compounds or otherwise, encapsulated on the microscopic level. The flat lamp maybe of the parallel electrode type or the newly made split electrode type.

The purpose of this invention is also met by using an in-circuit music sensitive device which causes the E.L. flat lamp to “pulsate” to the beat of the music influencing the deviate,

The purpose of this invention is also met when manipulating the lamp by bending, cutting, etching or otherwise, to yield a desired shape, logo, company name or any combination thereof.

### BRIEF DESCRIPTION OF THE SEVERAL VIEWS OF THE DRAWING

The foregoing and other aspects and applications of the present invention are not limited to, but made more clear in the following diagrams in addition to original FIGS. 1 through 4 where:

FIG. 5 illustrates the use of ratio transmitting and receiving circuits to activate the flat E.L. lamp circuit used with the present invention where “A” represents the transmitter circuit (outlined) “C” represents any connection enabling current to flow from the power source “G” to reach the main box “D” of the transmitter circuit. “E” is the main box of the receiver circuit “B”, “F” is the main power lead(s) that are directly spliced in-circuit with the electro-luminescent flat lamp circuit.

FIG. 6 illustrates the use of infra-red transmitting and receiving circuits to activate the flat E.L. lamp circuit used with the present invention where “A” is the infra-red transmitter circuit (outlined) “B” is the infra-red receiver circuit (outlined), “C” represents the input voltage path from a power source, “D” represents the output path of receiving circuit “B” allowing current to flow to the flat lamp circuit, when the receiver is acted upon by a specified frequency from the infra-red light emitting diode “E”.

### DETAILED DESCRIPTION OF THE INVENTION

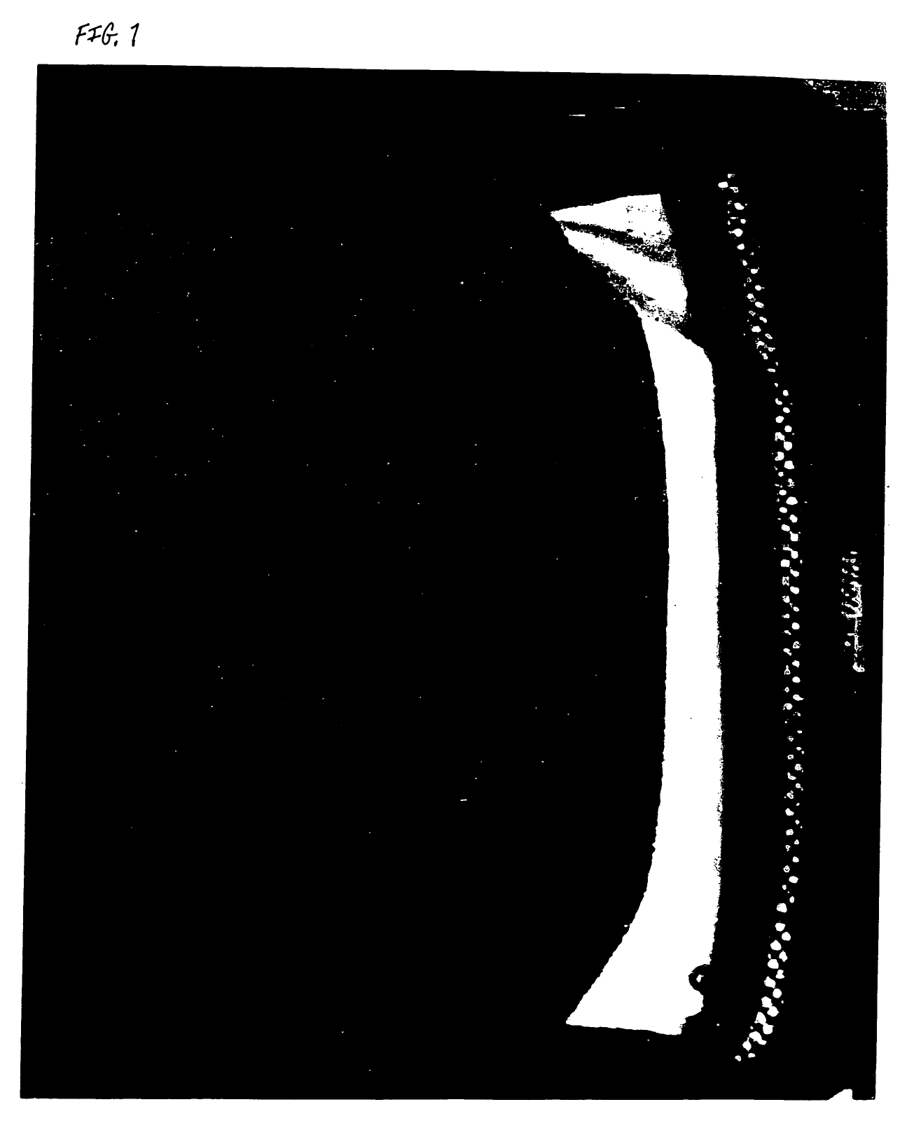

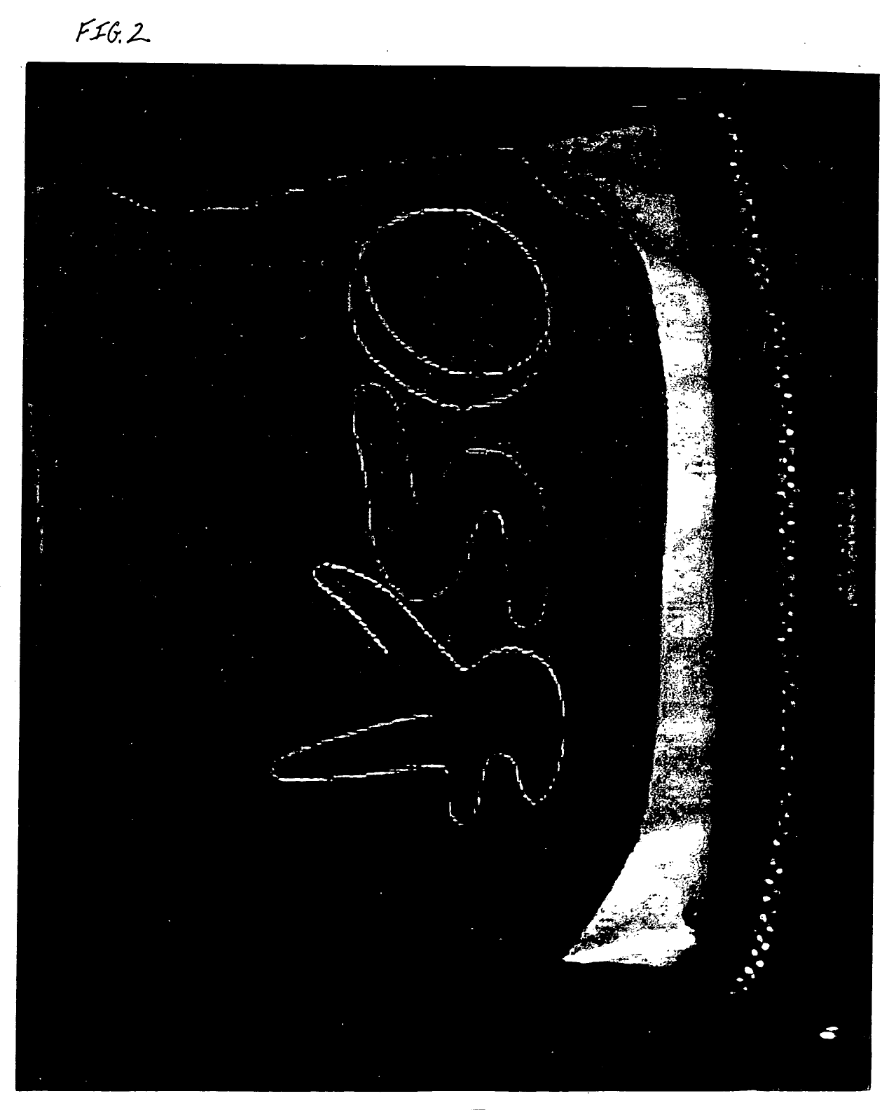

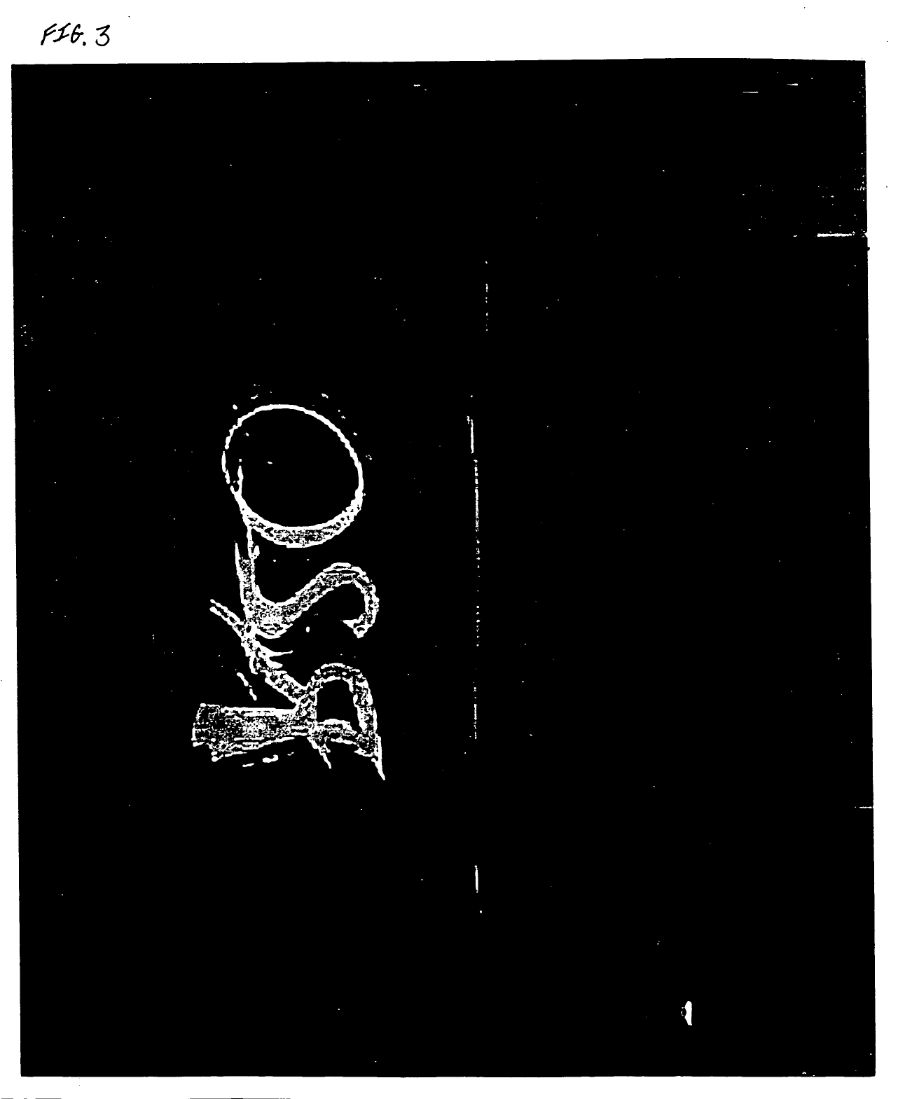

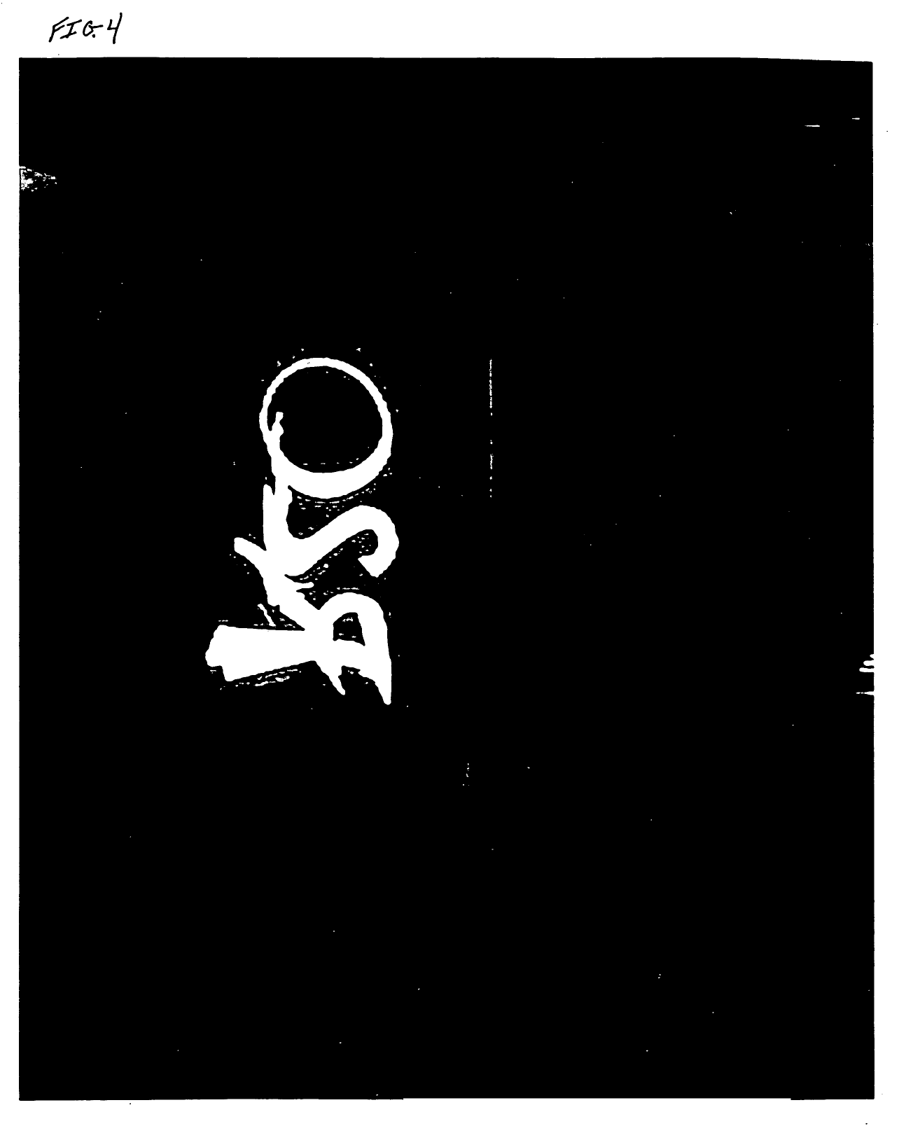

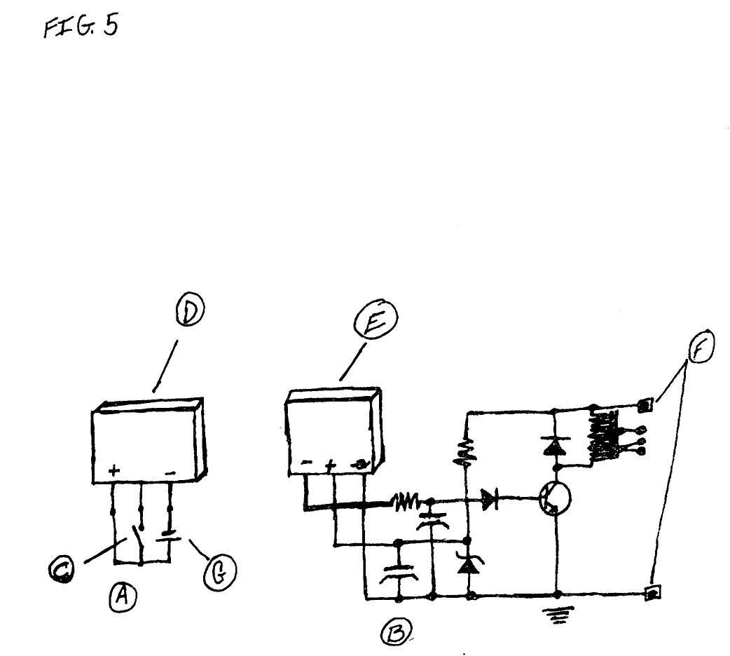

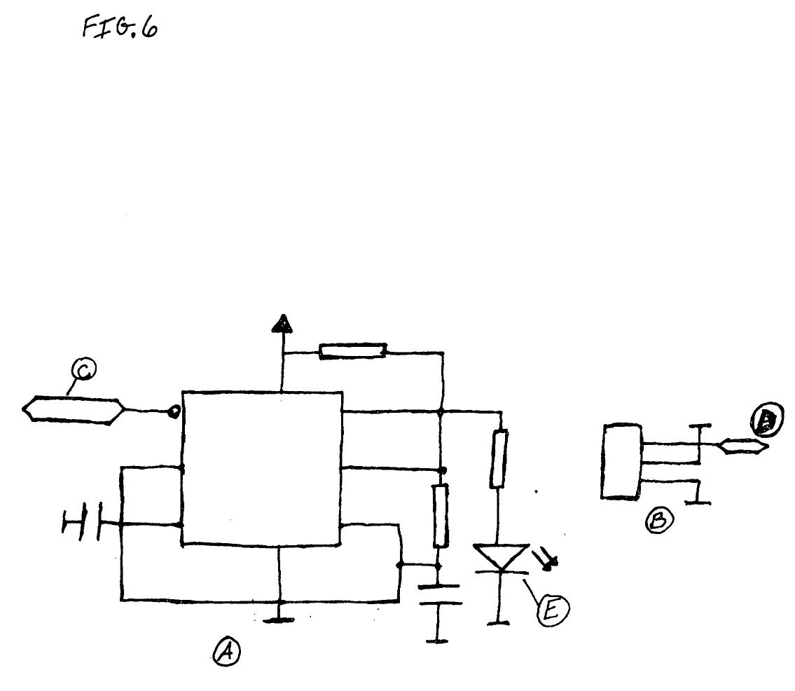

Electro-luminescent performance apparel is sport apparel (shirts, jackets, pants, helmets, etc.) to which an electro-luminescent flat lamp or lamps have been added to increase the visibility of the apparel, and incorporates the use of wireless circuitry (FIG. 5 and FIG. 6) to control the operation of the lamp for added comfort of the wearer.

The E.L. performance apparel may be used by all typed of emergency personnel, construction workers, dancers, motorcyclists, sport enthusiasts, joggers, etc.

Let it also be understood that E.L. performance apparel also can use E.L. flat lamps that produce special types of lighting that is not visible to the naked eye such as infra-red light. This is useful for example, during covert operations where the covert team would only want to be visible to perhaps the corresponding cover team using infra-red detection devices, however, stay “invisible” to the targeted objectives naked eyes.

Electro-luminescence is a process by which electricity is passed through a substance be it liquid, solid or gas, to produce “cold” light due to electrons in the substance elevating and returning back to different excitation levels and releasing energy in the form of light. This differs from incandescent lighting in that there is great heat generated in the incandescent lighting process. The electro-luminescence process generates light energy only with little or no heat at all. This makes it safe to use near fabric or anything else that would otherwise burn.

A relatively flat lamp or lamps are cut to the shape or emblem of choice and attached to the designated apparel. A circuit is connected so that when activated, the shape will glow. Activation takes place when by completing the circuit electricity passes from the power source through the flat shape causing it to illuminate (glow) the power source can be hardwired either from a vehicle (such as a motorcycle) battery or from an independent battery inside the apparel.

When wired to the vehicles power supply, more often than not, the necessary power to cause the electro-luminescent material to illuminate, will be tapped from the battery via the lighting system. For example, when the brakes are applied the brake lights illuminate. If the electro-luminescent material is spliced into the braking circuit, it will also illuminate. If the electro-luminescent material is spliced to the normal lighting system, when the lights are activated the material will also illuminate.

The electro-luminescent material can also be activated via “wireless” circuitry. For example, a transmitter connected in circuit to the brake light activates when the brake light is on, and sends a signal to the receptive circuit in the apparel which in turn connects the circuit to the electro-luminescent material from the battery inside the apparel itself.

Activation of the apparel when the wearer is not on a vehicle takes place by simply activating a switch directly connected to the aforementioned circuit. This switch for the purpose of this invention can be directly wired to the aforementioned circuit or can incorporate a wireless circuit, (FIG. 5) for activation, where a hand held wireless transmitting device (FIG. 5A) upon activation sends a signal to a corresponding receiving device (FIG. 5B) that is in-circuit of the electro-luminescent material. This signal interpreted by the receiving circuit will cause the flat E.L. lamp to illuminate until the transmitter is activated again.

For recreational purposes (such as discos, parties, clubs, etc.) a sound activated switch can be used as a means to connect the circuit. This interface reacts to a predetermined decibel level and when that decibel level is met or exceeded, the circuit is completed. This will make the electro-luminescent apparel appear like it's pulsing to the beat of a song, voices or any other sound that meets or exceed the predetermined decibel levels.

I claim as my invention:

1. Any article of clothing to be worn on the torso, head, waist and legs of a human comprising:
Any flat electro-luminescent lamp or lamps comprising of encapsulated electro-luminescent fibers phosphors or otherwise, attached to said article of clothing containing an integral power supply, to activate said lamp circuit.

2. The article of clothing from claim 1 wherein, said flat electro-luminescent lamp circuit is controlled by any wireless transmitting and receiving circuit.

3. The article of clothing in claim 1 where said flat E.L. lamp emits any kind of light including but not limited to infra-red light.

4. The article of clothing in claim 1 where said E.L. flat lamp emits any visible colors.

5. Article of clothing in claim 1 where said power supply is external of apparel but used directly or indirectly to said flat E.L. lamp circuit.

6. Article of clothing in claim 1 where said flat electro-luminescent lamp has been cut to create any shapes including but not limited to letters, symbols, pictures, and numbers.

7. Article of clothing in claim 1 where any transformer circuit is used in conjunction with said flat E.L. lamp circuit.

8. Article of clothing in claim 1 where attachment of flat E.L. lamp to apparel is permanent or temporary.
